(19) United States
(12) Patent Application Publication
(10) Pub. No.: US 2025/0073920 A1
(43) Pub. Date: Mar. 6, 2025

(54) APPARATUS AND METHOD FOR ENHANCED DETERMINATION OF OPTIMAL OPERATIONAL SEPARATION FOR COLLABORATIVE ROBOTIC SYSTEMS

(71) Applicant: Ohio State Innovation Foundation, Columbus, OH (US)

(72) Inventor: Christopher Tkach, Columbus, OH (US)

(21) Appl. No.: 18/825,158

(22) Filed: Sep. 5, 2024

Related U.S. Application Data
(60) Provisional application No. 63/622,763, filed on Jan. 19, 2024.
(60) Provisional application No. 63/580,496, filed on Sep. 5, 2023.

(51) Int. Cl. B25J 15/00; B23K 26/08; B25J 11/00

(52) U.S. Cl. CPC B25J 15/0019; B23K 26/0884; B25J 11/005

(57) ABSTRACT

A system may include a mounting body defining a plurality of openings extending therethrough, including a first opening and a second opening, the mounting body being couplable to a robotic arm. The system includes an end effector coupled to the robotic arm and comprising a working tip configured to interact with a workpiece. The system may include a laser system including a first laser device disposed within the first opening of the mounting body and a second laser device disposed within the second opening of the mounting body, each configured to emit a beam. The first laser device and the second laser device are each disposed at an adjustable angle with respect to each other wherein the first beam and the second beam cross each other at a confluence point, wherein the confluence point is calibrated to align with the working tip of the end effector.

### BACKGROUND

Collaborative robotic systems, often referred to as cobots, represent a transformative advancement in industrial automation. Unlike traditional industrial robots that are typically large, heavy, and designed to work in isolation behind safety barriers, cobots are designed to work alongside human operators collaboratively. This concept emerged as a response to the changing demands of manufacturing, where there is a growing need for flexible and adaptable automation solutions that can enhance productivity while maintaining a safe working environment for humans. Collaborative robotic systems have shown their utility in a variety of industries and processes, for example, pick and place operations, assembly, quality control and inspection, machine tending, collaborative welding, material handling, laboratory work, and healthcare.

Integrating cobots into existing workflows and systems can be complex. Ensuring compatibility with existing machinery, software, and processes requires careful planning and expertise. For example, the setup and calibration of a cobot for a particular task can be time-consuming and tedious. A human user may spend significant time ensuring the proper setup of a cobot before the actual work begins.

Therefore, a need exists to optimize the setup and initialization process of collaborative robotic systems.

### SUMMARY

In one implementation, a system is disclosed, the system including: a mounting body defining a plurality of openings extending therethrough, including a first opening and a second opening, the mounting body being couplable to a robotic arm (e.g., bolts); an end effector (e.g., welding gun) coupled to the robotic arm adjacent to the mounting body, the end effector including a working tip (e.g., welding wire) configured to interact with a workpiece; and a laser system including: a first laser device disposed within the first opening of the mounting body and configured to emit a first beam; and a second laser device disposed within the second opening of the mounting body and configured to emit a second beam, wherein the first laser device and the second laser device are each disposed at an adjustable angle with respect each other wherein the first beam and the second beam cross each other at a confluence point, wherein the confluence point is calibrated to align with the working tip of the end effector.

In some implementations, the confluence point of the intersecting beams demarcates an appropriate operational separation distance between the workpiece and the end effector for a given process. In some implementations, a separation distance between the first beam and the second beam on the workpiece such that the confluence point is not visible on the workpiece indicates a mismatched operational distance.

In some implementations, the mounting body further includes a plurality of adjustable knobs and corresponding set screws adjacent to the first and second openings, the plurality of adjustable knobs and corresponding set screws being configured to adjust the angle of the first laser device and/or the second laser device such that the confluence point is also adjusted.

In some implementations, the system further includes an illumination device (e.g., LED ring light) coupled to the mounting body, the illumination device configured to emit light substantially towards the confluence point. In some implementations, the system further includes a power source (e.g., 9V battery) configured to provide power to the laser system and/or the illumination device.

In some implementations, the robotic arm is an arm of a collaborative welding robot, wherein the end effector is a welding device, and wherein the working tip is an end of a welding wire protruding from the welding device.

In some implementations, the system further includes a plurality of servomotors coupled to the laser system and configured to adjust the angle of the first and second laser devices. In some implementations, the system further includes a camera system coupled to the mounting body and configured to detect either (i) a first case wherein the confluence point of the first and second beams on the workpiece or (ii) a second case wherein discrete points from the first and second beams on the workpiece are separated by a distance.

In some implementations, the system further includes a control system configured to (i) automatically adjust the laser system via the plurality of servomotors, (ii) automatically detect the presence or absence of the confluence point on the workpiece via the camera system, and (iii) automatically adjust the location of the end effector and the associated working tip in space with respect to the workpiece.

In some implementations, the laser system further includes a third laser device disposed within a third opening of the mounting body and configured to emit a third beam, wherein the third laser device is disposed at an adjustable angle with respect to the first and second laser devices such that the first beam, the second beam, and the third beam cross each other at the confluence point.

In one implementation, a method for aligning a collaborative robot system is disclosed, the method including: providing a workpiece; providing a robotic arm including: a mounting body coupled to an end of the robotic arm, the mounting body defining a plurality of openings extending therethrough, including a first opening and a second opening; an end effector (e.g., welding gun) coupled to the end of robotic arm adjacent to the mounting body, the end effector including a working tip (e.g., welding wire) configured to interact with the workpiece; and a laser system including a first laser device disposed within the first opening of the mounting body and configured to emit a first beam and a second laser device disposed within the second opening of the mounting body and configured to emit a second beam; extending the working tip of the end effector to a working configuration; adjusting an angle of the first laser device and an angle of the second laser device with respect to each other such that the first beam and the second beam cross each other at a confluence point, wherein the confluence point aligns with the working tip of the end effector; moving the robotic arm such that the working tip is adjacent to the workpiece and (i) if two discreate points from the first and second beams are visible on the workpiece, moving the robotic arm until the confluence point is visible, or (ii) if the confluence point is visible, setting a first alignment point of the collaborative robot system.

In some implementations, the method further includes moving the robotic arm to a second location on the workpiece and setting a second alignment point of the collaborative robot system; and activating the collaborative robot system to perform an operation on the workpiece based on the first and second alignment points.

In some implementations, the operation is a welding operation and the collaborative robot system is configured to weld the workpiece from the first alignment point to the second alignment point.

In some implementations, the laser system further comprises a third laser device disposed within a third opening of the mounting body and configured to emit a third beam, wherein the third laser device is disposed at an adjustable angle with respect to the first and second laser devices such that the first beam, the second beam, and the third beam cross each other at the confluence point, the method comprising: moving the robotic arm such that the working tip is adjacent to the workpiece and (i) if two or three discrete points from the first, second, and third beams are visible on the workpiece, moving the robotic arm until the confluence point is visible, or (ii) if the confluence point is visible, setting the first alignment point of the collaborative robot system.

In one implementation, a system is disclosed, the system including: a mounting body defining a first opening extending therethrough, the mounting body being couplable to a robotic arm (e.g., bolts); an end effector (e.g., welding gun) coupled to the robotic arm adjacent to the mounting body, the end effector including a working tip (e.g., welding wire) configured to interact with a workpiece; and a laser system including: a laser device disposed within the first opening of the body and configured to emit a primary beam; a beam splitter disposed adjacent to the laser device configured to split the primary beam into a first beam and a second beam; and a plurality of reflectors (e.g., mirrors) disposed at an adjustable angle with respect to the beam splitter, the first and second beams reflecting off of the plurality of reflectors, wherein the reflected first beam and second beam are each disposed at an adjustable angle with respect each other wherein the first beam and the second beam cross each other at a confluence point, wherein the confluence point is calibrated to align with the working tip of the end effector.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 shows a welding cobot system including a mounting body and a laser system alongside a diagram of a control system coupled to the welding cobot system, according to one implementation.

FIG. 2 shows an isometric view of a mounting body of the system of FIG. 1, according to one implementation.

FIG. 3 shows a top view of the mounting body of FIG. 2.

FIG. 4 shows a side view of the mounting body of FIG. 2.

FIG. 5 shows the difference between the confluence point and two discrete points from a laser system, according to one implementation.

FIG. 6 shows a detail view of the system of FIG. 2 with the mounting body mounted on an end of the welding cobot of FIG. 1 with the laser beams visible, according to one implementation.

FIG. 7 shows another detail view of the system of FIG. 2 with the visible laser beams crossing each other, according to one implementation.

FIGS. 8-11 each show a different view of the system of FIG. 7.

FIG. 12 shows a welding cobot including a system mounted on an end thereof further including battery packs and a ring-light illumination system, according to one implementation.

FIG. 13 shows a different view of the system of FIG. 12.

FIG. 14 shows a front-on view of the system of FIG. 12.

FIG. 15 shows a diagram of a laser system of the present disclosure including a single laser device and a splitter/reflector system, according to one implementation.

FIG. 16 shows a welding cobot system including a mounting body and a laser system each coupled to a robotic arm, according to one implementation.

FIG. 17 shows a side view of the system of FIG. 16.

FIG. 18 shows a mounting bracket of the system of FIG. 16, according to one implementation.

FIGS. 19-22 show different views of the mounting bracket of FIG. 18.

FIG. 23 shows an image of a prototype mounting bracket, according to one implementation.

FIG. 24 shows an image of an example cobot next to the prototypical mounting bracket of FIG. 23, according to one implementation.

FIG. 25 shows an image of the welding cobot system of FIG. 24 with the mounting bracket installed thereon, according to one implementation.

FIGS. 26 and 27 show diagrams of laser beams and their associated focal points, according to one implementation.

FIGS. 28-30 show images of differently aligned laser beams on a workpiece, according to various implementations.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

The systems, methods, and devices disclosed herein facilitate user-guided determination of optimal operational separation between a collaborative robot (cobot) and a workpiece, thereby enhancing the user's efficacy in configuring and programming the cobot unit. The systems, methods, and devices disclosed herein enable users to ascertain an ideal working distance between a collaborative robot (cobot) and a workpiece, thereby facilitating the precise configuration and programming of the cobot unit.

The systems, methods, and devices disclosed herein utilize and incorporate precisely directed beams, which can be selectively positioned to establish distinct operational distances. The beams can be immobilized for recurring, unvaried processes, or repositioned to denote the distinct operational distances. The underlying premise involves the alignment of the beams at a calculated angle to accurately demarcate the appropriate operational separation for a given process. The confluence point of the intersecting beams designates the precise operational distance-a singular locus where they coalesce. Conversely, in the event of a mismatched operational distance, the presence of multiple discrete points becomes evident.

By virtue of their spatial orientation and calculated angles, the beams converge at a singular, predetermined point, denoting the accurate operational separation. Should a deviation in distance occur, this configuration produces multiple distinct points, revealing a discrepancy in the operational distance. The multiple discrete points indicate a mismatched operational distance and visually communicate the mismatched operational distance to a user or a control system.

In some implementations, an illumination device is incorporated. The illumination device augments visibility and accuracy during distance assessment. This illuminating adjunct may constitute the primary component or an integral constituent within a broader operational framework. This illuminative module can function as a standalone element or seamlessly integrate within a broader system architecture.

In sum, the systems, methods, and devices disclosed herein provide a novel approach to achieving precise operational separation and additional visibility through illumination and configuration within collaborative robotic systems in the field of industrial automation and robotics.

### Example System #1

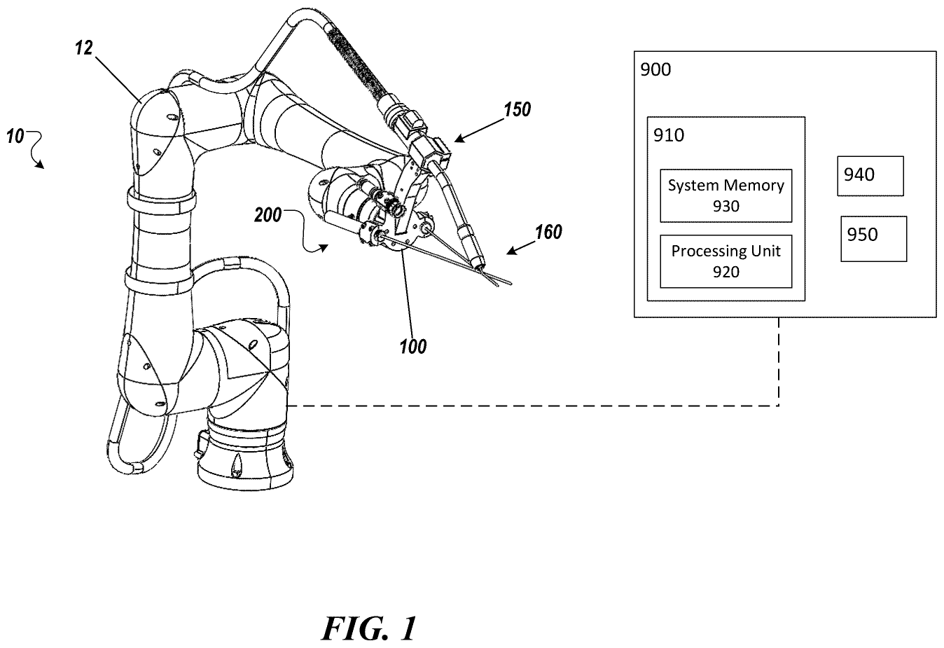

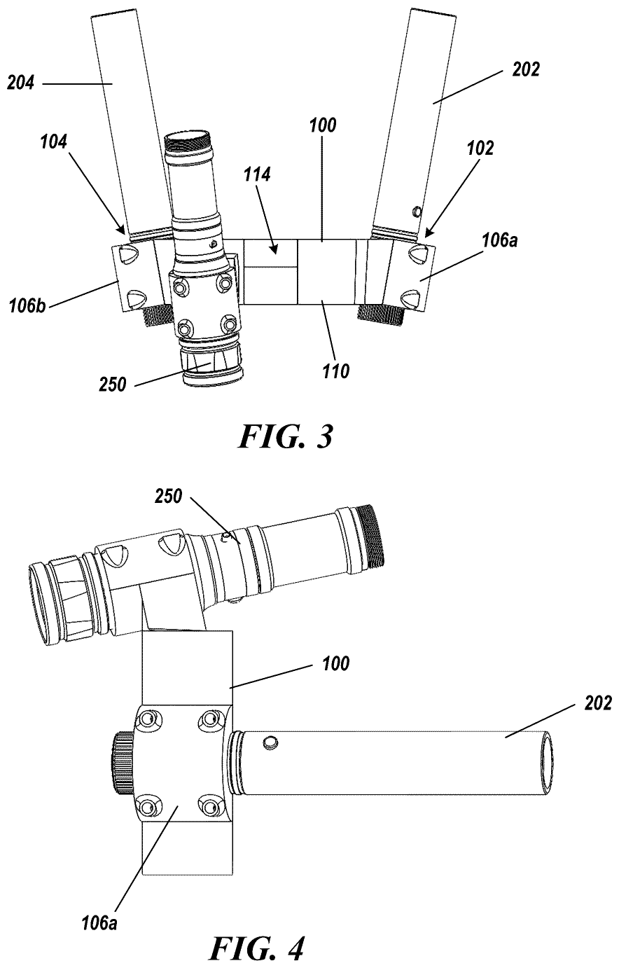

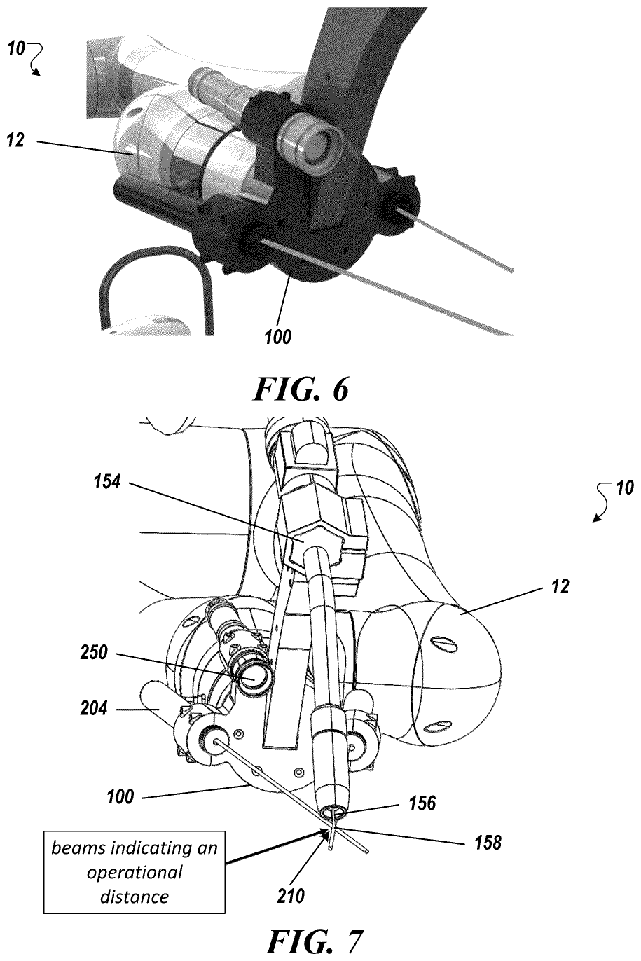

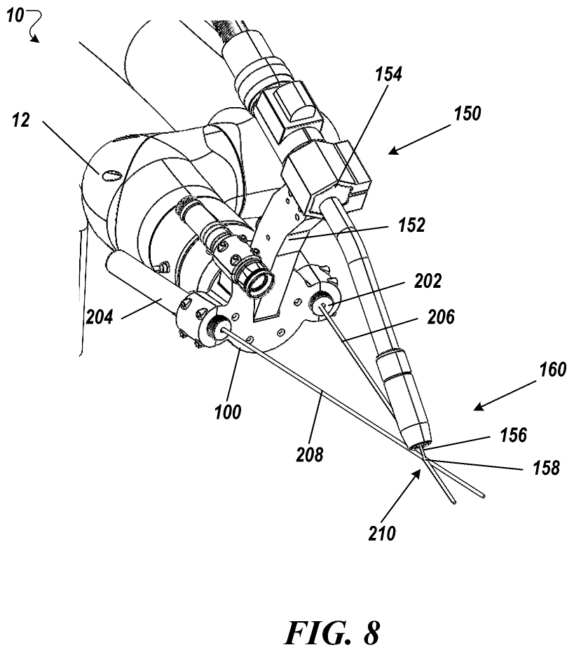

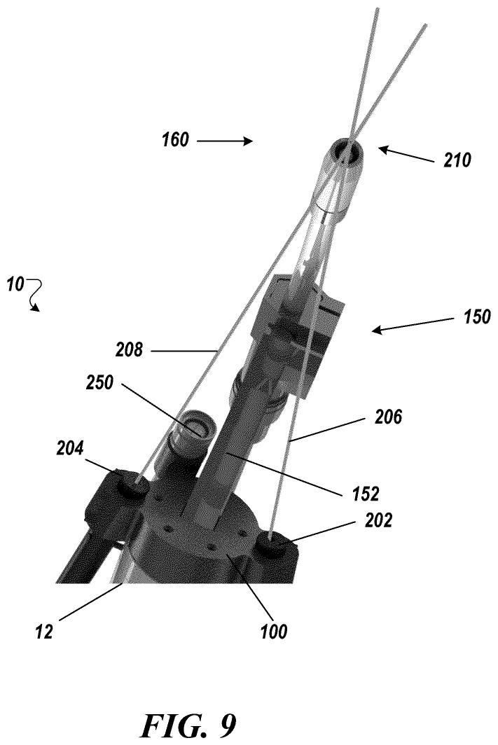

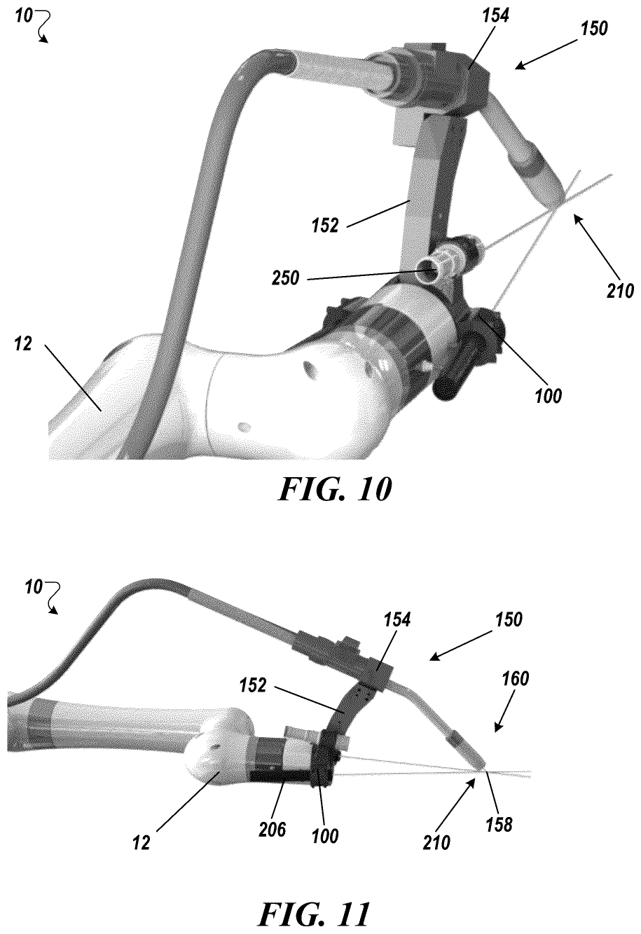

Referring generally to the figures, a collaborative welding robot is shown, according to various implementations. FIGS. 1-11 show a model of the overall welding cobot including a system mounted on an end thereof, according to a first implementation. The collaborative welding cobot of the present example provides for a streamlined process of aligning and calibrating the robotic arm and the associated system. As will be understood by the description herein, a user can easily adjust the laser beams to align with a welding wire to define the desired operational distance. Then, a user (or computing device) can easily identify the same operational distance between the welding device and a workpiece by aligning the confluence point of the laser beams on the workpiece. In this way, several alignment points on the workpiece can be quickly and efficiently identified.

FIGS. 1-11 show a system 10 that includes a mounting body 100 (e.g., a bracket, plate, or attachment) couplable to the robotic arm 12 (e.g., via bolts into the end of the robotic arm). The system 10 further includes an end effector 150 (e.g., a welding device or other manufacturing tool) couplable to the robotic arm 12. The system further includes a laser system 200 couplable to the mounting body 100.

The mounting body 100 may be a plate- or bracket-type device having an overall shape configured to couple to the robotic arm 12. For example, the mounting body 100 includes a first portion 110 defining a plurality of screw holes 112. A plurality of screws or bolts may be inserted through the screw holes 112 to attach the first portion 110 of the mounting body 100 to the robotic arm 12. The first portion 110 further defines a slot 114 substantially centered on the first portion 110. The slot 114 receives a portion of the robotic arm 12 when the mounting body 100 is coupled to the robotic arm 12. The slot 114 accommodates the portion of the robotic arm 12 (e.g., a strut or member of the robotic arm 12). The slot 114 may also accommodate a portion of the end effector 150 extending from the robotic arm 12.

In other implementations, the mounting body 100 may coupled to the robotic arm 12 in a different manner. For example, the mounting body may include snap-fit protrusions configured to snap onto a portion of the robotic arm. In other implementations, the mounting body may include internal threads configured to screw onto a portion of the robotic arm. In other implementations, the mounting body and a portion of the end effector may be integrally formed.

The mounting body 100 defines a plurality of openings including, at least, a first opening 102 and a second opening 104. The mounting body 100 further includes retaining portions 106a, 106b on opposite sides of the first portion 110. The first opening 102 is defined in part by the first portion 110 and further in part by the retaining portion 106a. The second opening 104 is defined in part by the first portion 110 and further in part by the retaining portion 106b.

The first and second openings 102, 104 are configured to receive and retain a portion of the laser system 200 (e.g., a laser device thereof), as further described below. The retaining portions 106a, 106b are each removably coupled to the first portion 110 of the mounting body 100 (e.g., via one or more screws, one or more bolts, one or more ratcheting devices, one or more clamping devices, or any other fastening device configured to retain a body within the first or second opening 102, 104).

The end effector 150 of the system 10 of FIGS. 1-11 is a welding device, and the effector 150 is coupled to the robotic arm 12 adjacent to the mounting body 100. The end effector 150 includes a supporting member 152 coupled on one end to the robotic arm 12 through the slot 114 of the mounting body 100.

The opposite end of the supporting member 152 includes a coupling portion 154 (e.g., an opening configured to retain a portion of the end effector 150). For example, the coupling portion 154 may receive and retain a portion of the welding device (e.g., an electrode holder, an electrode cable, and/or a gas line).

The end effector 150 includes a welding wire 158 (e.g., a welding wire or electrode) extending out from a distal end 160 of the end effector 150 or the welding device. The welding wire 158 defines a working tip 156 configured to interact with a workpiece. The welding device is configured to deliver the wire 158 from the end of the end effector 150 to a desired location with respect to the workpiece.

The working tip 156 may be separated from the distal end 160 of the welding device by a distance which may change depending on the operation. The distance that the working tip 156 of the welding wire 158 is separated from the base metal or workpiece is dependent upon the contact-tip-to-work-distance and the welding process being undertaken. For example, a different workpiece material or size may affect the distance that the welding wire extends out from the welding device/end effector. In existing welding systems, adjusting and maintaining the working tip of the welding wire to the proper working distance may be difficult and may require multiple adjustments and checks.

The laser system 200 of the system 10 is configured to align the robotic arm 12 and the working tip 156 of the end effector 150 with the workpiece (e.g., to a proper working distance). The laser system 200 includes a first laser device 202 disposed within the first opening 102 of the mounting body 100. The laser system 200 includes a second laser device 204 disposed within the second opening 104 of the mounting body 100. Each of the first laser device 202 and the second laser device 204 are configured to emit a laser beam from an end thereof. The first laser device 202 is configured to emit a first beam 206, and the second laser device 204 is configured to emit a second beam 208.

The first laser device 202 and the second laser device 204 are each disposed at an adjustable angle with respect to each other. Thus, the first beam 206 and the second beam 208 are adjustable with respect to each other based on the respective angles of the first laser device 202 and the second laser device 204. For example, a portion of the mounting body 100 may be adjustable to move the first opening 102 and/or the second opening 104 (e.g., an axis extending through the respective opening) to a desired angle, thus moving the laser device disposed therein.

A user or a controller (e.g., of an automated control system) can control the angle of the laser devices 202, 204 (e.g., the angle of one longitudinal axis of the laser device with respect to another, and the respective beams emitted from the laser devices). For example, the first and second beams 206, 208 may be aligned in the same plane or different planes. In either case, the first and second beams 206, 208 may be adjusted such that the first beam 206 and the second beam 208 cross each other at a confluence point 210.

The confluence point 210 may be calibrated to align with the working tip 156 of the distal end 160 of the end effector 150. For example, a user or a controller (e.g., of an automated control system) can adjust each of the first and second laser devices 202, 204 to emit their corresponding beams 206, 208 at an angle wherein each of the beams 206, 208 hits the working tip 156 of the welding wire 158. By aligning each of the beams 206, 208 with the working tip 156 of the welding wire 158, the two beams 206, 208 will cross at the working tip 156 of the welding wire 158 (i.e., the confluence point is aligned with the tip of the welding wire).

In some implementations, the mounting body 100 further includes a plurality of adjustable knobs and corresponding set screws adjacent to the first and second openings 102, 104. The plurality of adjustable knobs and corresponding set screws are configured to adjust the angle of the first laser device 202 and/or the second laser device 204 such that the confluence point 210 is also adjusted. For example, each opening for each laser device may have an associated set screw for fixing the angle of the laser beam. Furthermore, each opening may include one knob for adjusting the angle of each laser with respect to an associated axis (e.g., an x-, y-, and z-axis).

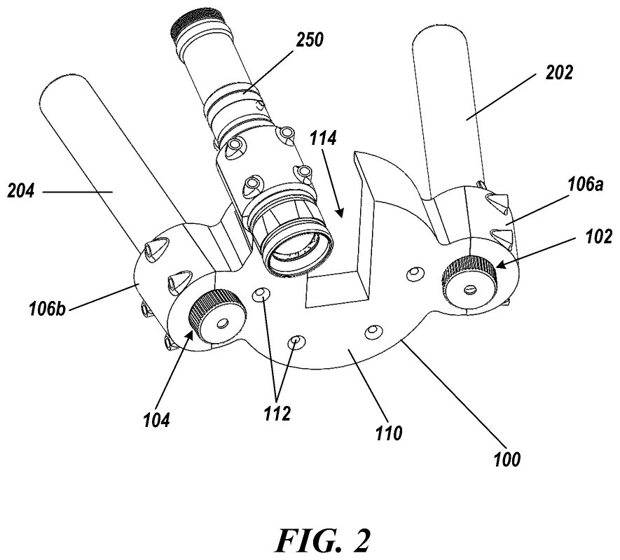

The system further includes an illumination device 250 (e.g., flashlight or LED ring light) coupled to the mounting body 100. For example, the illumination device 250 may be separately coupled to the first portion 110 of the mounting body 100, or the illumination device 250 may be disposed and retained within an opening device in the mounting body 100 (e.g., a third opening). FIG. 2 shows a flashlight implementation of the illumination device 250; however, in other implementations, the illumination device is a different type of light source. The illumination device 250 is configured to emit light substantially towards the confluence point 210 to aid in the user's vision (or a control system's vision) of the workpiece adjacent to the end effector 150. Such an illumination device 250 may be used in factory or lab settings wherein lighting near the workpiece is limited.

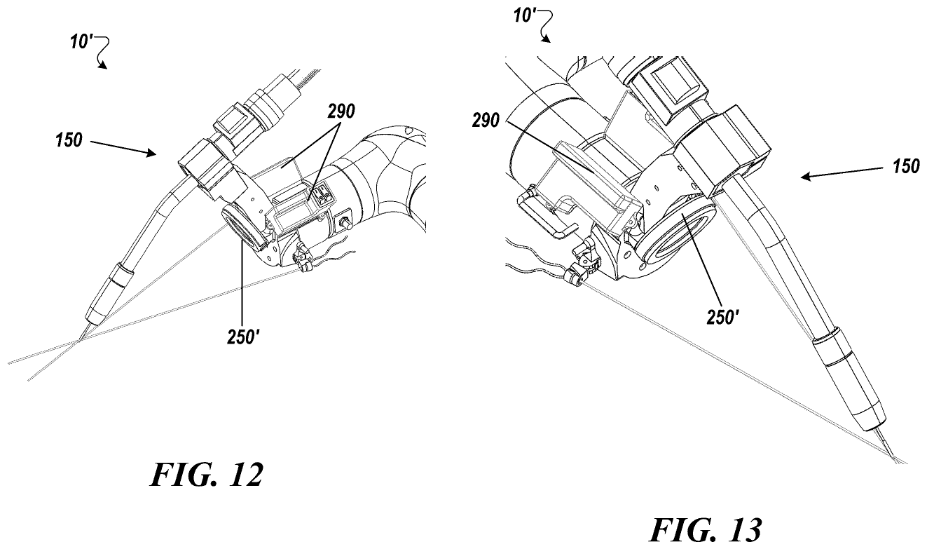

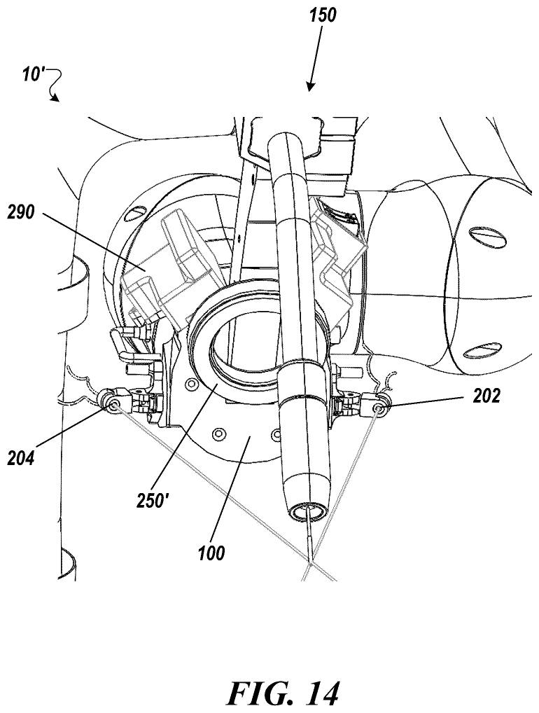

FIGS. 12-14 show another implementation of the system 10 of FIGS. 1-11. However, the system 10′ in FIGS. 12-14 includes a ring light implementation of the illumination device. The ring light 250′ in the system 10′ provides a similar function as the illumination device 250 in the system 10. Furthermore, the system 10′ includes a power source 290 coupled to the mounting body 100. The power source 290 includes one or more 9V batteries in the system 10′. However, in other implementations, the power source may be a direct wiring or electrical connection to a power port of the robotic arm or coupled thereto. The power source 290 may provide power to one or more of the laser devices of the laser system and/or the illumination device.

In use, a user or a control system (e.g., of an automated control system) can align the cobot (e.g., the robotic arm 12) with a workpiece to perform an operation on it (e.g., welding along a seam). First, a workpiece is provided, along with the system 10 shown and described herein.

The working tip 156 of the welding wire 158 is extended from the end effector 150 (e.g., the welding device) to a working configuration. For example, the welding wire 158 may be extended out from the welding device ¾ inches for a particular temperature, material, or type of operation.

The angle of the first and second laser devices 202, 204 is adjusted such that the first and second beams 206, 208 cross each other at the working tip 156 of the welding wire 158. In this configuration, the confluence point 210 of the first and second beams 206, 208 is aligned with the working tip 156 of the welding wire 158. In some implementations, the welding wire is retracted into the welding device until the cobot is ready to perform the operation.

The robotic arm 12 is moved (translated, angled, or otherwise articulated) such that the working tip 156 and/or end effector 150 is adjacent to the workpiece. To verify the alignment of the end effector 150 with the workpiece (e.g., the operational distance between the end effector and the workpiece), the user (or a control system system) verifies that the confluence point 210 of the beams 206, 208 is aligned with the desired location on the workpiece.

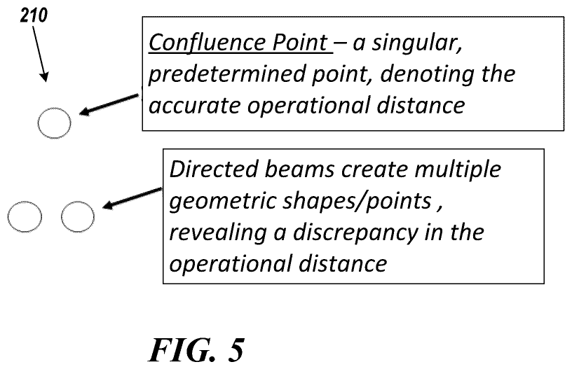

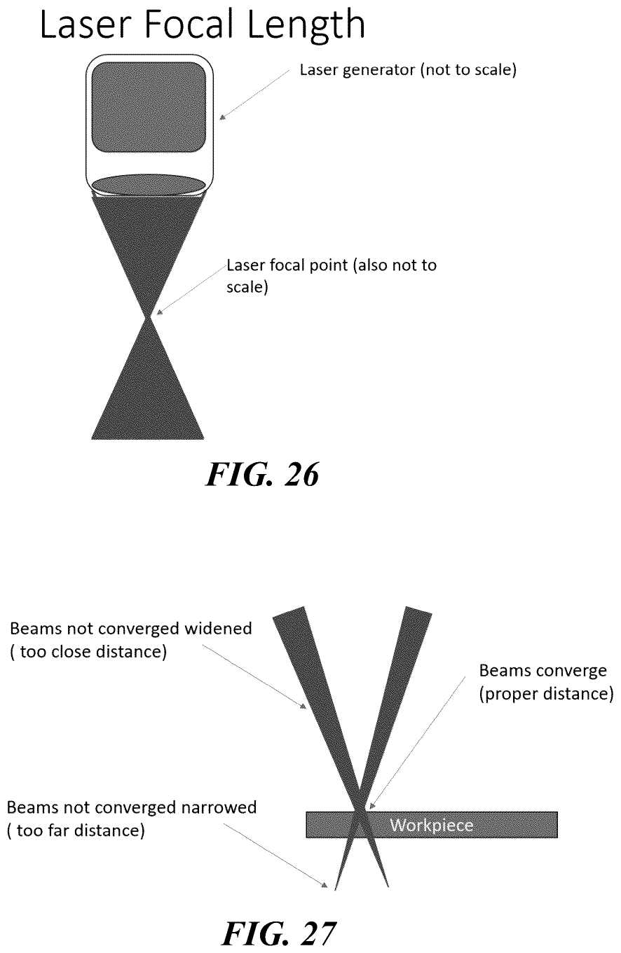

If two discrete points from the first and second beams are visible on (or adjacent to) the workpiece, then the confluence point is not adequately aligned. For example, in FIG. 5, the lower portion shows two discrete beams, representing a mismatched operational distance. In other words, the distance between the workpiece and the end effector is misaligned or mismatched. This could mean that the end effector is too close (such that the two beams have yet to cross) or too far away (such that the beams have crossed and diverged). See also FIGS. 26-30, further described below, describing another implementation and explanation of discrete versus singular beams and which direction of out-of-focus the end effector may be.

However, if only one point (the confluence point 210) is visible, then the end effector 150 is properly aligned (e.g., the distance between the distal end 160 of the end effector 150 is a proper working distance from the workpiece, and the working tip 156 of the welding wire 158 is, or will be once extended, properly aligned with the workpiece. The confluence point 210 of the intersecting beams demarcates an appropriate operational separation distance between the workpiece and the end effector for a given process. FIG. 5 shows the difference between the confluence point and two discrete points from the laser system. Although the beam contact location is shown as a circle, in other implementations, the beam contact location shape (and corresponding confluence point shape) is a different shape (e.g., an ellipse).

Once aligned, the first alignment point of the collaborative robot system 10 is then set/saved. In some implementations, the process is repeated for a second alignment point or a plurality of alignment points. For example, it may be desirable to obtain two alignment points along a straight-line seam in order to perform a welding process on that seam from the first point to the second point. In other implementations, a third alignment point may enable welding along a seam having two straight line sections or a curved section. In either case, the control system of the collaborative robot system can adjust the operation once the alignment points are set.

Therefore, the systems shown and described provide for a more efficient process of aligning and configuring a welding cobot. Rather than manually lining up each point with the working tip, a user (or control system) need only set the working tip distance once. Then, aided by the laser system, the user (or control system) can verify and set a plurality of alignment points on the workpicce.

### Example Automated System

FIG. 1 shows the system 10 further including a computing device 900 coupled to the robotic arm 12 and the systems attached thereto (e.g., the laser system 200, the end effector 150, and/or the mounting body 100). The computing device 900 may represent the controller, control system, or automated control system elsewhere described with reference to the system 10. It should be understood that the example computing device 900 is only one example of a suitable computing environment upon which implementations of the system may be implemented. Optionally, the computing device 900 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 900 typically includes at least one processing unit 920 and system memory 930. Depending on the exact configuration and type of computing device, system memory 930 may be volatile (such as random access memory (RAM)), non-volatile (such as read-only memory (ROM), flash memory, etc.), or some combination of the two. This most basic configuration is illustrated in FIG. 1 by line 910. The processing unit 920 may be a standard programmable processor that performs arithmetic and logic operations necessary for the operation of the computing device 900. While only one processing unit 920 is shown, multiple processors may be present. Thus, while instructions may be discussed as executed by a processor, the instructions may be executed simultaneously, serially, or otherwise executed by one or multiple processors. The computing device 900 may also include a bus or other communication mechanism for communicating information among various components of the computing device 900.

The processing unit 920 may be configured to execute program code encoded in tangible, computer-readable media. Tangible, computer-readable media refers to any media that is capable of providing data that causes the computing device 900 (i.e., a machine) to operate in a particular fashion. Various computer-readable media may be utilized to provide instructions to the processing unit 920 for execution. Example tangible, computer-readable media may include, but is not limited to, volatile media, non-volatile media, removable media and non-removable media implemented in any method or technology for storage of information such as computer readable instructions, data structures, program modules or other data. System memory 930, removable storage 940, and non-removable storage 950 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 920 may execute program code stored in the system memory 930. For example, the bus may carry data to the system memory 930, from which the processing unit 920 receives and executes instructions.

The systems, methods, and devices disclosed herein may incorporate an automated control system to activate and adjust various elements of the cobot and the associated mounted laser alignment system. For example, in a welding cobot operation, the computing device 900 may include an automated system that may be implemented to (1) extend the welding wire to a predetermined distance, (2) adjust the first and second laser devices to align the confluence point with the tip of the welding wire, (3) optionally retract the welding wire, (4) move the welding device adjacent to a desired location on a workpiece, (5) with or without the aid of a human, align the confluence point at the desired location on the workpiece, (6) automatically identify when the confluence point is visible such that the operational distance of the welding device is optimal, (7) repeat the process of alignment and identification for a number of desired locations, and (8) perform a welding operation based on the alignment locations/desired locations.

An example automated system may include the computing device 900 and the processing unit 920 thereof configured to (i) automatically adjust the laser system via the plurality of servomotors, (ii) automatically detect the presence or absence of the confluence point on the workpiece via the camera system, and (iii) automatically adjust the location of the end effector and the associated working tip in space with respect to the workpiece.

In an example automated system, a plurality of servomotors are coupled to the laser system and configured to adjust the angle of the first and second laser devices. Each servo motor may be controlled by a cobot control system (e.g., a processor of the cobot control system).

An example automated system may further include a camera system coupled to the mounting body and configured to detect either (i) a first case wherein the confluence point of the first and second beams on the workpiece or (ii) a second case wherein discrete points from the first and second beams on the workpiece are separated by a distance. The camera of the camera system may detect light in the visible spectrum or infrared. A processor of the camera system (either separate from or the same as the processor of the cobot control system) may be configured to analyze the images from the camera and make the determination of the first case or the second case.

### Example Reflector System

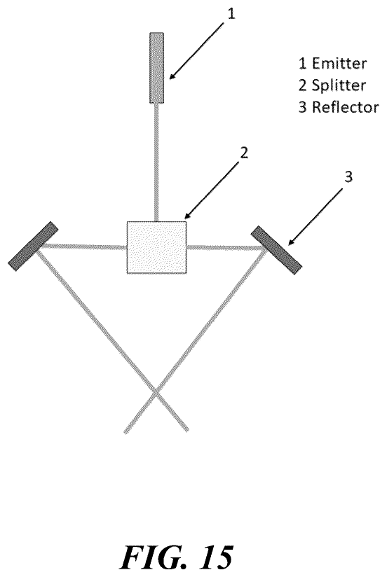

The systems, methods, and devices disclosed herein may include a reflector system such that only one laser device is required. A diagram of the example reflector system is shown in FIG. 15. The example reflector system may simplify the operation of the laser alignment and reduce the number of moving parts and/or degrees of freedom involved with the laser alignment.

The example reflector system may replace a portion of the system 10 and/or the laser system 200 as elsewhere described, or the example reflector system may augment a portion of the system 10 and/or the laser system 200 thereof. The example reflector system may be coupled to the mounting body 100 of the system 10.

The example reflector system includes a laser device (e.g., “Emitter”) disposed within the first opening of the body and configured to emit a primary beam. The example reflector system further includes a beam splitter (e.g., “Splitter”) disposed adjacent to the laser device configured to split the primary beam into a first beam and a second beam. The example reflector system further includes a plurality of reflectors (e.g., mirrors or “Reflectors”) disposed at an adjustable angle with respect to the beam splitter, the first and second beams reflecting off of the plurality of reflectors. The reflected first beam and second beam are each disposed at an adjustable angle with respect to each other wherein the first beam and the second beam cross each other at a confluence point. The confluence point is calibrated to align with the working tip of the end effector.

Similar to the system 10 having two laser devices 202, 204, the system incorporating the example reflector system can adjust the beam angles to align at a desired operational distance with respect to the end effector. Rather than moving the laser devices, this system adjusts the angles of the mirrors within the reflector system to achieve beam adjustment.

### Example System #2

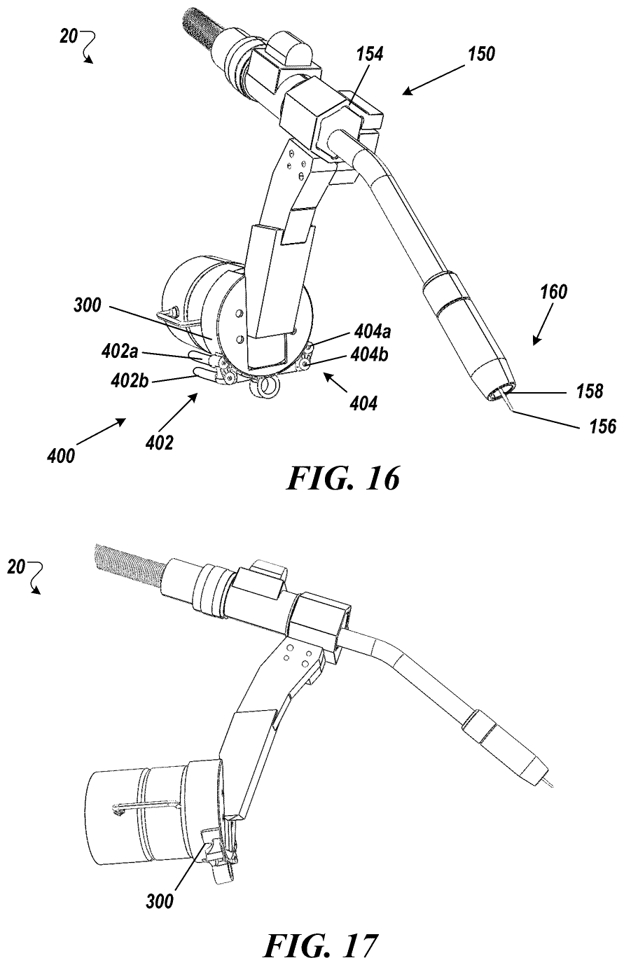

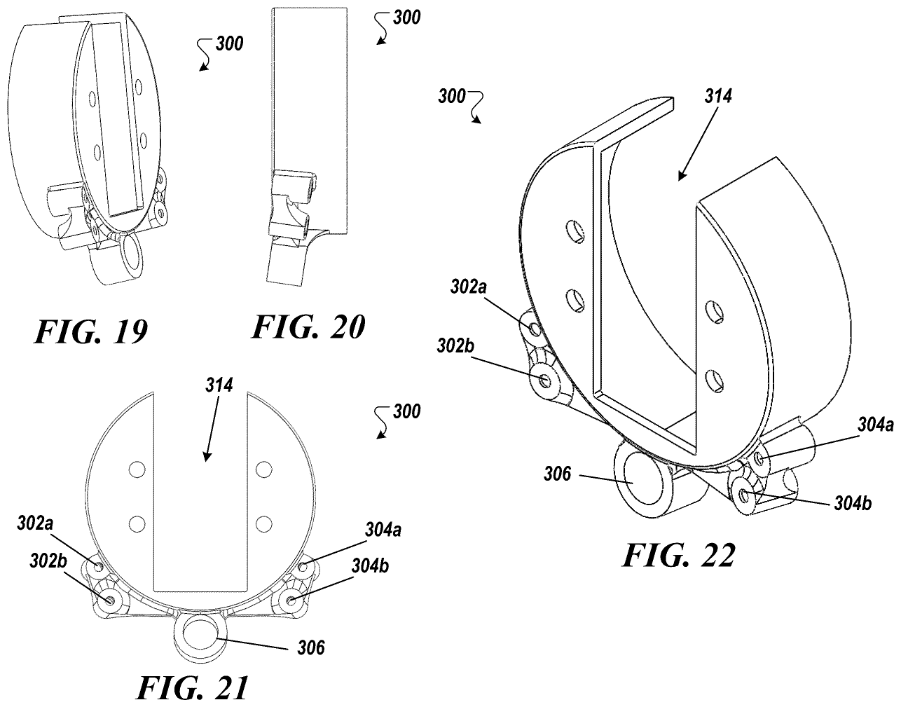

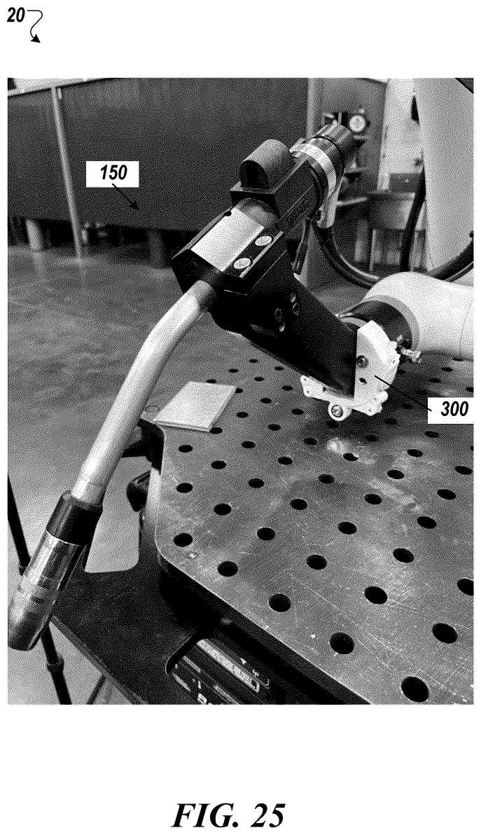

A collaborative welding robot according to another implementation is shown in FIGS. 16-25. The system 20 of FIGS. 16-25 is substantially similar to the system 10 except as described below. For example, the system 20 includes the end effector 150 with the welding wire 158 defining the working tip 156. However, the system 20 includes a mounting bracket 300 that is different from the mounting body 100 and a laser system 400 that is different from the laser system 200. For example, the system 20 includes multiple sets of lasers (e.g., diode lasers) configured to designate multiple confluence points. However, it is understood that other structural and functional aspects described herein are applicable to the present example system. For example, the automation of various elements is contemplated as elsewhere described.

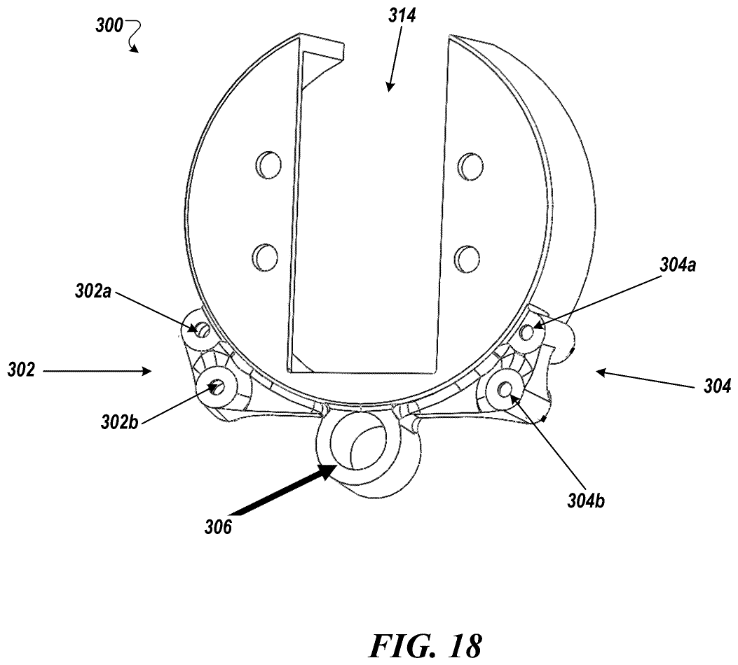

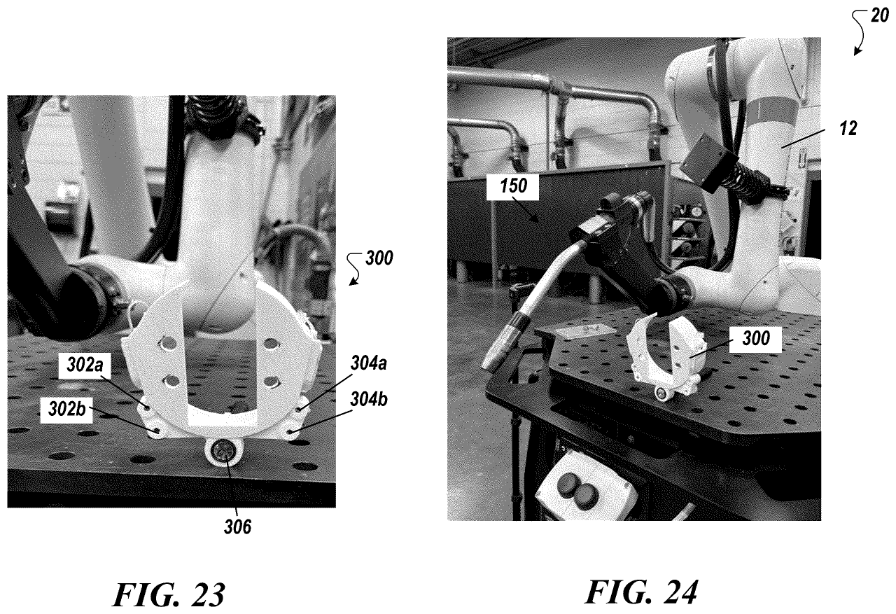

As best seen in FIG. 18, the mounting bracket 300 of the system 20 is coupable to the robotic arm 12 (e.g., via bolts through the openings defined in the mounting bracket 300 and into the end of the robotic arm 12). The mounting bracket 300 includes a slot 314 configured to facilitate installation and accommodate a portion of the end effector 150. The mounting bracket 300 includes may comprise a variety of rigid materials (e.g., metal or plastic). As one example, the mounting bracket 300 shown in the images in FIGS. 23-25 comprises ABS plastic and was manufactured via 3D printing.

The mounting bracket 300 defines a first set of openings 302 including a first opening 302a and a second opening 302b on a first side of the mounting bracket 300. The mounting bracket 300 further includes a second set of openings 304 including a third opening 304a and a fourth opening 304b. Each of the openings of the first and second sets of openings 302, 304 are configured to accommodate individual laser devices around the periphery of the mounting bracket 300.

The mounting bracket 300 further includes a fifth opening 306 located between the first set of openings 302 and the second set of openings 304. The fifth opening 306 is configured to accommodate an illumination device (e.g., the illumination device 250 of the system 10).

The mounting bracket 300 can accommodate multiple laser systems or multiple sets of laser devices. For example, laser system 400 includes a first pair of laser devices 402 and a second pair of laser devices 404. The first pair of laser devices 402 includes a first laser device 402a and a second laser device 402b. The second pair of laser devices 404 includes a third laser device 404a and a fourth laser device 404b.

The first laser device 402a is disposed within the first opening 302a, and the second laser device 402b is disposed within the second opening 302b adjacent to the first opening 302a. The third laser device 404a is disposed within the third opening 304a, and the fourth laser device 404b is disposed within the fourth opening 304b adjacent to the third opening 304a.

Each laser device of the respective pair of laser devices is disposed at an adjustable angle with respect to each other. For example, the first laser device 402a and the second laser device 402b of the laser devices 402 are installed in the mounting bracket 300 adjacent to one another and are configured to operate together (e.g., pointing their respective laser beams towards the same confluence point). In other implementations, the mounting bracket 300 and associated welding cobot system 20 may include more than two sets of laser devices (e.g., 3, 4, 5, 6, 7, 8, or 10 sets of laser devices) depending on the application and use case. In other implementations, the sets of laser devices may include more than two laser devices operating in tandem (e.g., 3, 4, 5, 6, 7, 8, or 10 individual lasers) depending on the application and use case.

The welding cobot system 20 having multiple sets of lasers may generate multiple confluence points. For example, the first pair of laser devices 402 may be aligned to define a first confluence point, while the second set of laser devices 404 may be aligned to define a second confluence point. The first and second confluence points may be separated in space by a distance in any direction relative to each other or to the welding device. For example, the first confluence point and the second confluence point may each be defined along an axis of a welding wire 158 of the welding device, wherein the first and second confluence points are separated by a first distance along that axis.

In some implementations, multiple sets of multiple lasers may be used to designate different contact tip to work distances (CTWD), which may be defined as the distance between the distal end 160 of the end effector 150 and the working tip 156 of the welding wire 158. The contact tip to work distance (CTWD) may also be defined as the distance that the working tip 156 of the welding wire 158 extends out from the distal end 160 of the end effector 150. For example, the first confluence point from the first set of laser devices 402 may define a first CTWD while the second confluence point from the second set of laser devices 404 may define a second CTWD.

In a system where two CTWDs are defined, the system does not need to adjust the laser devices (either manually or automatically via motors) to designate different CTWD's. Instead, two or more CTWDs may be defined before a welding operation, and different laser device sets may be used (e.g., turned on/off, or aligned with the working tip or welding wire) to change the CTWD. The various CTWDs may be used, for example, for changes in material type, welding process, modes of metal transfer, and other variables. In some implementations, a multitude of laser systems each having a multitude (e.g., 2 or more) of laser devices is contemplated by this disclosure. In some implementations, a multitude of laser systems may include at least three sets of laser devices, each set of laser devices defining a confluence point associated with a different CTWD. In some implementations, a multitude of CTWD's are defined and/or set for each laser system based on a variety of factors, including but not limited to: the welding operation type, the geometry of the workpiece (e.g., a corner or a flat portion), the material thickness, or the type of metal.

In use, a user or a control system (e.g., an automated control system) can align the robotic arm 12 with a workpiece to perform an operation on it (e.g., welding along a scam). First, a workpiece is provided, along with the system 20 shown and described herein.

The working tip 156 of the welding wire 158 is extended from the end effector 150 (e.g., the welding device) to a working configuration. For example, the welding wire 158 may be extended out from the welding device a first working distance or CTWD (e.g., ¾ inches) for a particular temperature, material, or type of operation. The angles of the first and second laser devices 402a, 402b of the first set of laser devices 402 are adjusted such that the first and second beams cross each other at the working tip 156 of the welding wire 158. In this configuration, the first confluence point of the first set of laser devices 402 is aligned with the working tip 156 of the welding wire 158.

Next, the working tip 156 of the welding wire 158 is extended from the end effector 150 (e.g., the welding device) to a second working configuration. For example, the welding wire 158 may be extended out from the welding device a second working distance or CTWD (e.g., 1.25 inches) for a particular temperature, material, or type of operation. The second working distance or CTWD differs from the first working distance or CTWD. The angle of the third and fourth laser devices 404a, 404b of the second set of laser devices 404 is adjusted such that the first and second beams cross each other at the working tip 156 of the welding wire 158. In this configuration, the second confluence point of the second set of laser devices 404 B is aligned with the working tip 156 of the welding wire 158. Therefore, the first confluence point and the second confluence point are defined with respect to the first and second CTWD, respectively.

Similar to the above examples, the robotic arm 12 is moved (translated, angled, or otherwise articulated) such that the working tip 156 is adjacent to the workpiece. To verify the alignment of the end effector 150 with the workpiece (e.g., the operational distance between the end effector and the workpiece), the user or control system (e.g., an automated control system or the computing device 900 of FIG. 1) verifies that a confluence point of the beams is aligned with the desired location on the workpiece.

However, the user or the control system also verifies that the correct confluence point is in use. For example, the user or the control system may turn off the first set of laser devices 402 such that only the beams and second confluence point from the second set of laser devices 404 are visible. Then, during a different operation, a user or the control system may turn off the second set of laser devices 404 such that only the beams and the first confluence point from the first set of laser devices 402 are visible.

For each confluence point, if two discrete points from the first and second beams are visible on (or adjacent to) the workpiece, then the confluence point is not adequately aligned. However, if only one point (the confluence point) is visible, then the end effector is properly aligned.

Once aligned, the first alignment point of the collaborative robot system 20 is then set/saved. In some implementations, the process is repeated for a second alignment point or a plurality of alignment points. For example, it may be desirable to obtain two alignment points along a straight-line seam in order to perform a welding process on that seam from the first point to the second point. In other implementations, a third alignment point may enable welding along a seam having two straight line sections or a curved section. In either case, the control system of the collaborative robot system can adjust the operation once the alignment points are set.

Therefore, the systems shown and described provide for a more efficient process of aligning and configuring a welding cobot. Rather than manually lining up each point with the working tip, a user (or control system) need only set the working tip distance once. Then, aided by the laser system, the user (or control system) can verify and set a plurality of alignment points on the workpiece.

### Distance Correction and Visual Indication

This disclosure describes the use of laser confluence points as a guide for a user or a control system to (i) gather information about the location of a working tip of a welding cobot, (ii) adjust the working tip of the welding cobot, and/or (iii) identify errors in the location of the working tip of the welding cobot. For example, a singular laser point/circle on a workpiece may indicate correct alignment, while the existence of multiple laser points on a workpiece may indicate incorrect alignment. However, it may be difficult for a user or system to identify the type of error associated with multiple laser points. Separate points alone do not indicate whether the working tip is too close or too far from the proper work distance/confluence point.

In some implementations, the altered focal points of the laser can indicate to a user or a control system whether the working tip and the confluence point are too close or too far from each other. For example, FIG. 26 provides a simple diagram of a laser generator wherein a laser beam has a focal point somewhere along the laser beam. As shown in FIG. 27, the selected/adjusted confluence point of the two laser beams may take into consideration the beam focal length. Closer to the source, the laser beams are too wide, which may lead to imprecision and a larger confluence point than desired. Further from the source, beyond the focal point, the laser beams start to lose focus and may have an imprecise shape. The confluence point shown in FIG. 27 is a point where both lasers have narrowed somewhat, but neither laser has reached the focal point. However, in other implementations, the confluence point may be at the focal point of one or more of the lasers.

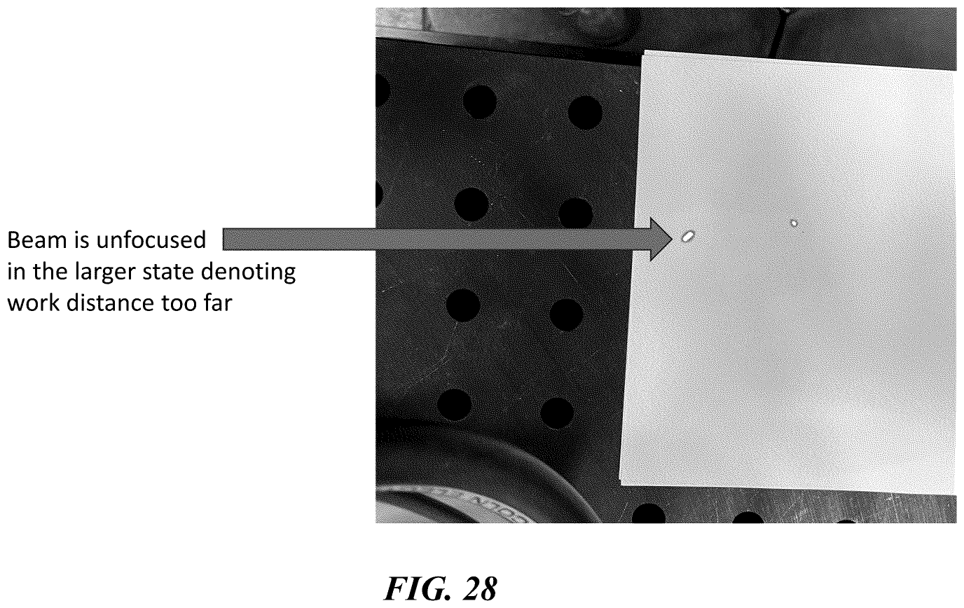

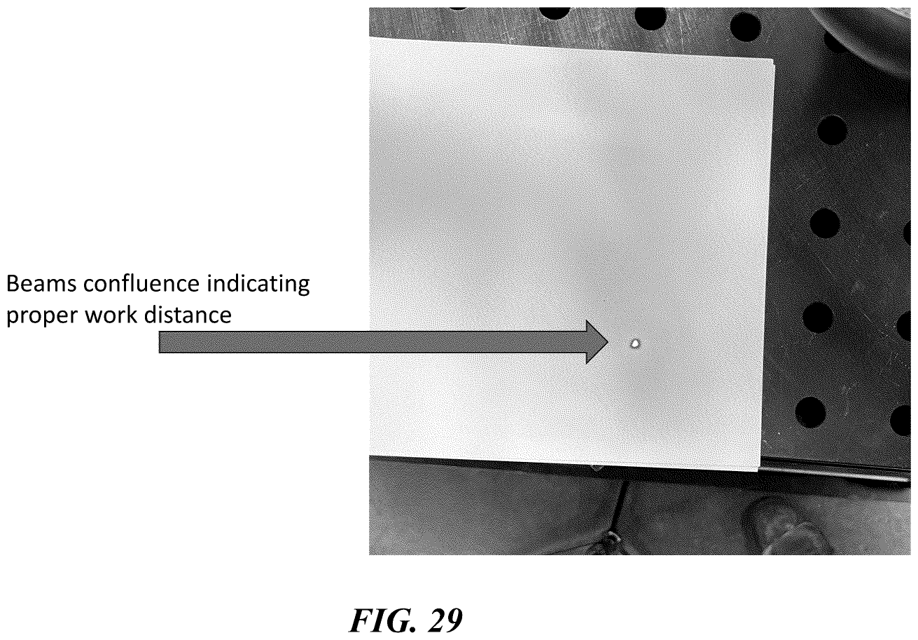

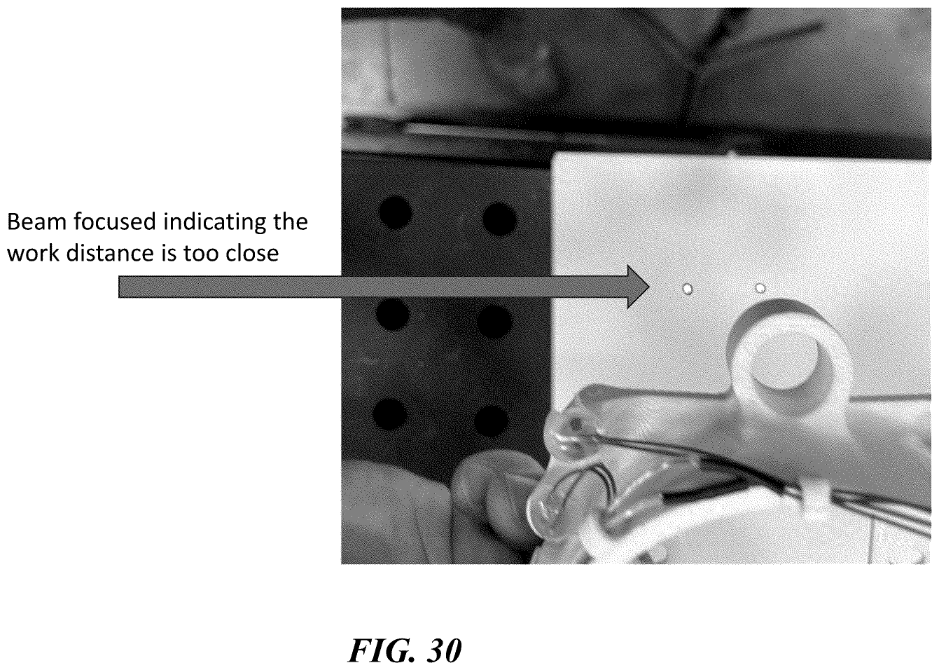

In use, the focal point of the lasers can be used to identify whether the workpiece is too close or too far from the workpiece. For example, in FIG. 28 two laser beam points are visible on the workpiece, indicating a misalignment. Furthermore, the points are unfocussed and have an oblong and larger-than-normal shape on the workpiece. The unfocused and larger-state laser beam points indicate that the workpiece is too far away. FIG. 29 shows a single confluence point, indicating that the beams are aligned and the workpiece is at the proper working distance. FIG. 30 shows two laser points visible on the workpiece, indicating a misalignment. Furthermore, the points are focused, having a regular or circular shape on the workpiece. The focused and regular shape of the laser beam points indicates that the workpiece is too close.

In other implementations, various shapes and focus levels of the laser beam points may be used to identify a workpiece/working tip distance error. The focal point of the laser may be adjusted (e.g., by replacing the laser device) for a desired welding operation and/or a desired confluence point. Furthermore, a user and/or an automated control system may be trained to identify a focused or unfocused laser beam point on the workpiece and adjust the system accordingly.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

1. A system comprising:
a mounting body defining a plurality of openings extending therethrough, including a first opening and a second opening, the mounting body being couplable to a robotic arm;
an end effector coupled to the robotic arm adjacent to the mounting body, the end effector comprising a working tip configured to interact with a workpiece; and
a laser system comprising:
a first laser device disposed within the first opening of the mounting body and configured to emit a first beam; and
a second laser device disposed within the second opening of the mounting body and configured to emit a second beam,
wherein the first laser device and the second laser device are each disposed at an adjustable angle with respect to each other wherein the first beam and the second beam cross each other at a confluence point,
wherein the confluence point is calibrated to align with the working tip of the end effector.

2. The system of claim 1, wherein the confluence point of the first and second beams demarcates an appropriate operational separation distance between the workpiece and the end effector for a given process.

3. The system of claim 1, wherein a separation distance between the first beam and the second beam on the workpiece such that the confluence point is not visible on the workpiece indicates a mismatched operational distance.

4. The system of claim 1, wherein the mounting body further comprises a plurality of adjustable knobs and corresponding set screws adjacent to the first and second openings, the plurality of adjustable knobs and corresponding set screws being configured to adjust the angle of the first laser device and/or the second laser device such that the confluence point is also adjusted.

5. The system of claim 1, further comprising:
an illumination device coupled to the mounting body, the illumination device configured to emit light substantially towards the confluence point.

6. The system of claim 5, further comprising:
a power source configured to provide power to the laser system and the illumination device.

7. The system of claim 1, wherein the robotic arm is an arm of a collaborative welding robot, wherein the end effector is a welding device, and wherein the working tip is an end of a welding wire protruding from the welding device.

8. The system of claim 1, further comprising a plurality of servomotors coupled to the laser system and configured to adjust the angle of the first and second laser devices.

9. The system of claim 1, further comprising a camera system coupled to the mounting body and configured to detect either (i) a first case wherein the confluence point of the first and second beams on the workpiece or (ii) a second case wherein discrete points from the first and second beams on the workpiece are separated by a distance.

10. The system of claim 1, further comprising a control system configured to (i) automatically adjust the laser system via a plurality of servomotors, (ii) automatically detect the presence or absence of the confluence point on the workpiece via a camera system, and (iii) automatically adjust the location of the end effector and the associated working tip in space with respect to the workpiece.

11. The system of claim 1, wherein the laser system further comprises a third laser device disposed within a third opening of the mounting body and configured to emit a third beam, wherein the third laser device is disposed at an adjustable angle with respect to the first and second laser devices such that the first beam, the second beam, and the third beam cross each other at the confluence point.

12. A method for aligning a collaborative robot system, the method comprising:
providing a workpiece;
providing a robotic arm comprising:
a mounting body coupled to an end of the robotic arm, the mounting body defining a plurality of openings extending therethrough, including a first opening and a second opening;
an end effector coupled to the end of the robotic arm adjacent to the mounting body, the end effector comprising a working tip configured to interact with the workpiece; and
a laser system comprising a first laser device disposed within the first opening of the mounting body and configured to emit a first beam and a second laser device disposed within the second opening of the mounting body and configured to emit a second beam;
extending the working tip of the end effector to a working configuration;
adjusting an angle of the first laser device and an angle of the second laser device with respect to each other such that the first beam and the second beam cross each other at a confluence point, wherein the confluence point aligns with the working tip of the end effector;
moving the robotic arm such that the working tip is adjacent to the workpiece and
(i) if two discrete points from the first and second beams are visible on the workpiece, moving the robotic arm until the confluence point is visible, or
(ii) if the confluence point is visible, setting a first alignment point of the collaborative robot system.

13. The method of claim 12, further comprising:
moving the robotic arm to a second location on the workpiece and setting a second alignment point of the collaborative robot system; and
activating the collaborative robot system to perform an operation on the workpiece based on the first and second alignment points.

14. The method of claim 13, wherein the operation is a welding operation and the collaborative robot system is configured to weld the workpiece from the first alignment point to the second alignment point.

15. The method of claim 12, wherein the laser system further comprises a third laser device disposed within a third opening of the mounting body and configured to emit a third beam, wherein the third laser device is disposed at an adjustable angle with respect to the first and second laser devices such that the first beam, the second beam, and the third beam cross each other at the confluence point, the method comprising:
moving the robotic arm such that the working tip is adjacent to the workpiece and
(i) if two or three discrete points from the first, second, and third beams are visible on the workpiece, moving the robotic arm until the confluence point is visible, or
(ii) if the confluence point is visible, setting the first alignment point of the collaborative robot system.

16. The system of claim 1, wherein
the laser system further comprises:
a beam splitter disposed adjacent to either the first laser device or the second laser device, the beam splitter configured to split the first or second beam from the first or second laser device into a first split beam and a second split beam; and
a plurality of reflectors disposed at an adjustable angle with respect to the beam splitter, the first and second split beams reflecting off of the plurality of reflectors,
wherein the reflected first split beam and the reflected second split beam are each disposed at an adjustable angle with respect to each other wherein the first split beam and the second split beam cross each other at a confluence point,
wherein the confluence point is calibrated to align with the working tip of the end effector.

17. A system comprising:
a mounting body defining a plurality of openings extending therethrough, the mounting body configured to couple to a robotic arm comprising an end effector with a working tip;
a first laser system comprising a first laser device configured to emit a first beam and a second laser device configured to emit a second beam, each of the first and second laser devices being disposed within one of the plurality of openings of the mounting body,
wherein the first laser device and the second laser device are each disposed at an adjustable angle with respect to each other, wherein the first beam and the second beam cross each other at a first confluence point associated with a first alignment distance of the working tip of the end effector; and
a second laser system comprising a third laser device configured to emit a third beam and a fourth laser device configured to emit a fourth beam, each of the third and fourth laser devices being disposed within one of the plurality of openings of the mounting body,
wherein the third laser device and the fourth laser device are each disposed at an adjustable angle with respect to each other, wherein the third beam and the fourth beam cross each other at a second confluence point associated with a second alignment distance of the working tip of the end effector.

18. The system of claim 17, wherein the first confluence point and the second confluence point are separated by a first distance in a plane of the working tip of the end effector.

19. The system of claim 17, wherein the first laser system and the second laser system are each selectively controllable to turn on or off based on a specific operation or location of the end effector.

20. The system of claim 17, further comprising:
a plurality of laser systems coupled to the plurality of openings of the mounting body, wherein any one of a plurality of confluence points is defined where at least two beams emitting from at least two laser devices of one of the plurality of laser systems cross each other to indicate a contact tip work distance associated with the working tip of the end effector.

21. (canceled)

22. (canceled)
